(19) United States
(12) Patent Application Publication
(10) Pub. No.: US 2011/0310067 A1
(43) Pub. Date: Dec. 22, 2011

(54) PORTABLE ELECTRONIC EQUIPMENT AND METHOD FOR CONTROLLING STARTUP OF APPLICATION THEREOF

(75) Inventor: Hiroaki Miura, Kanagawa (JP)

(73) Assignee: KYOCERA CORPORATION, Kyoto (JP)

(21) Appl. No.: 13/203,367

(22) PCT Filed: Feb. 25, 2010
(86) PCT No.: PCT/JP2010/001282

§ 371 Date: Aug. 25, 2011

(30) Foreign Application Priority Data
Feb. 25, 2009 (JP) 2009-043181

(51) Int. Cl. G09G 5/00

(52) U.S. Cl. 345/184

(57) ABSTRACT

Provided is a portable electronic equipment which gives a feeling of speedy operation free from strange feeling, and has a function operability which is more suitable to the actual usage pattern of a user. A portable electronic equipment is provided with a casing, a rotary dial section (41) rotatably fixed to the casing, a rotation detection section (201) which detects rotation of the rotary dial section (41), an application startup section (202) which starts up a predetermined application among a plurality of applications based on the rotation detected by the rotation detection section (201), a device confirmation section (203) which confirms a device to be used in a new application which is started up by the application startup section (202), a decision section (204); which decides whether a first device is identical to a second device which is operating when start of rotation of the rotary dial section (41) is detected, and a control section (205) which maintains the second device in started state when a decision is made that the first device is identical to the second device by the decision section (204).

### TECHNICAL FIELD

The present invention relates to portable electronic equipment having a rotary dial portion and an application activation control method therefor.

### BACKGROUND ART

Cellular telephones are made multifunctional by installing radio and television reception functions or a navigation function according to a navigation system, in addition to communication and call functions. In such cellular telephones, a communication/call standby screen is displayed as a top screen in a case in which a function such as a television reception function is not selected. When the user performs a predetermined operation, the standby screen transitions to a menu selection screen for selecting the other functions, and the user selects a predetermined function on the menu selection screen, thereby making it possible to activate a desired function.

However, since a number of functions are listed on the menu selection screen, it is difficult for an inexperienced user to perform an operation smoothly, and such a user may hesitate to use the portable electronic apparatus itself in some cases. There is a demand for a more intuitive user interface. For example, in a cellular telephone of a flip type having a hinge portion, a cellular telephone is proposed in which a hinge portion is provided with a rotary dial to be used for volume control and the like (e.g., refer to Patent Document 1).

In addition, a digital camera is known in which a mode change operation can be performed by a rotary dial. A menu that assists in a mode change operation, such as changing from a normal photographing mode to a movie mode (recording moving images) or a continuous shooting mode (taking multiple still images in a short time) and the like, is allocated to be selectable to this rotary dial (e.g., refer to Patent Document 2).
[Patent Publication 1] Japanese Unexamined Patent Application, First Publication No. H06-90200
[Patent Publication 2] Japanese Unexamined Patent Application, First Publication No. 2001-245189

### DISCLOSURE OF THE INVENTION

### Problems to be Solved by the Invention

Recent cellular telephones are different from digital camera only with a camera application in which only switching between functions of the camera application is expected. In other words, cellular telephones include many different applications other than the camera application, such as communication and call functions.

In Patent Documents 1 and 2, it is not expected that many different applications such as a music playing application and a web browsing application are included.

The present invention is aimed at providing: portable electronic equipment providing speedy operability with no discomfort by employing a rotary dial and having operability of functions that is more suitable for an actual mode of usage by a user; and an application activation control method.

### Means for Solving the Problems

In order to solve the abovementioned problem, portable electronic equipment according to the present invention includes: a body; a rotary dial portion that is attached to the body so as to be rotatable; a rotation detection unit that detects rotation of the rotary dial portion; an application activation processing unit that activates a predetermined application among a plurality of applications based upon the rotation detected by the rotation detection unit; a device confirmation unit that confirms a device used by a new application activated by the application activation processing unit; a determination unit that determines whether the first device is the same as a second device that is active when start of rotation of the rotary dial portion is detected; and a control unit that maintains a state where the second device is activated in a case in which the determination unit determines that the first device is the same as the second device.

In the portable electronic equipment, it is preferable that the application activation processing unit determines the new application by identifying a rotation position of the rotary dial portion.

In the portable electronic equipment, it is preferable that the rotary dial portion is provided with a plurality of icons and, among the plurality of icons, at least two adjacent icons correspond to two applications that use the same device.

In the portable electronic equipment, it is preferable that applications that use the same device are allocated adjacently to each other in the rotary dial portion.

In the portable electronic equipment, it is preferable that the control unit quits the second device and controls the first device confirmed by the device confirmation unit to be activated, in a case in which the determination unit determines that the first device is not the same as the second device.

In the portable electronic equipment, it is preferable that: in a case in which the determination unit determines that the first device is not the same as the second device, the control unit determines whether the second device is of a type that maintains operation in an inactive state of the current application; and, in a case in which the control unit determines that the second device is of the type that maintains operation in the inactive state, the control unit does not quit the second device that is currently active.

In the portable electronic equipment, it is preferable that: in a case in which the control unit determines that the second device is of the type that maintains operation in the inactive state, the control unit executes the new application and activates the first device without quitting the second device.

In the portable electronic equipment, it is preferable that, in a case in which the determination unit determines that the first device is not the same as the second device, the control unit determines whether the second device is of a type that maintains operation in an inactive state of the current application and, in a case in which the control unit determines that the second device is of the type that maintains operation in the inactive state, the control unit outputs information for determination of whether operation of the second device should be maintained or quitted.

In the portable electronic equipment, it is preferable that a condition for determining that the second device is of the type that maintains operation in the inactive state is that the current application is at least one of the following:

A. a music playing application that plays music data stored in memory;

B. a video playing application that converts received signal into video and sound and outputs the video and the sound;

C. a sound output application that converts received signal into sound and outputs the sound; and

D. a guiding application that guides a user to a destination based on positional information.

It is preferable that the portable electronic equipment further includes: a storage unit that stores a control table that represents correspondence between the plurality of applications and devices used by each application, in which the device confirmation unit confirms a device used by the new application by referring to the control table stored in the storage unit.

In order to solve the abovementioned problem, an application activation control method for a portable electronic equipment with a rotary dial portion rotatably attached thereto according to the present invention includes: a detection step of detecting rotation of the rotary dial portion; an application activation step of activating a predetermined application among a plurality of applications based upon the rotation detected in the detection step; a confirmation step of confirming a device used by a new application activated in the application activation step; a determination step of determining whether a first device confirmed in the confirmation step is the same as a second device that is active when start of rotation of the rotary dial portion is detected; and a control step of maintaining a state where the second device is activated in a case in which, in the determination step, the first device is determined to be the same as the second device.

### EFFECTS OF THE INVENTION

According to the present invention, portable electronic equipment provides speedy operability with no discomfort by employing a rotary dial and has operability of functions that is more suitable for an actual mode of usage by a user.

### BRIEF DESCRIPTION OF THE DRAWINGS

FIG. 1 is a diagram showing appearance of a cellular telephone according to the present invention;

FIG. 2 is a diagram showing an appearance of the cellular telephone in a closed state, which is viewed from a display unit side body;

FIG. 3 is a diagram showing an appearance of the cellular telephone in the closed state, which is viewed from an operation unit side body;

FIG. 4 is a diagram showing a vicinity of a rotary dial portion in an enlarged manner;

FIG. 5 is a diagram illustrating functions of the rotary dial portion;

FIG. 6 is a functional block diagram showing functions of the cellular telephone;

FIG. 7 is a functional block diagram showing functions of a processing unit of the cellular telephone;

FIG. 8 is a flowchart illustrating operations of the cellular telephone;

FIG. 9 is a timing chart illustrating an operation of switching devices upon activation of an application; and

FIG. 10 is a flowchart illustrating an operation in a case in which an activation operation of a new application is performed during use of an application that is executable in an inactive state.

### EXPLANATION OF REFERENCE NUMERALS

1 Cellular telephone
2 Operation unit side body
3 Display unit side body
41 Rotary dial portion
70 Processing unit
701 Rotation detecting unit
202 Application activation processing unit
203 Device confirmation unit
204 Determination unit
205 Control unit

### PREFERRED MODE FOR CARRYING OUT THE INVENTION

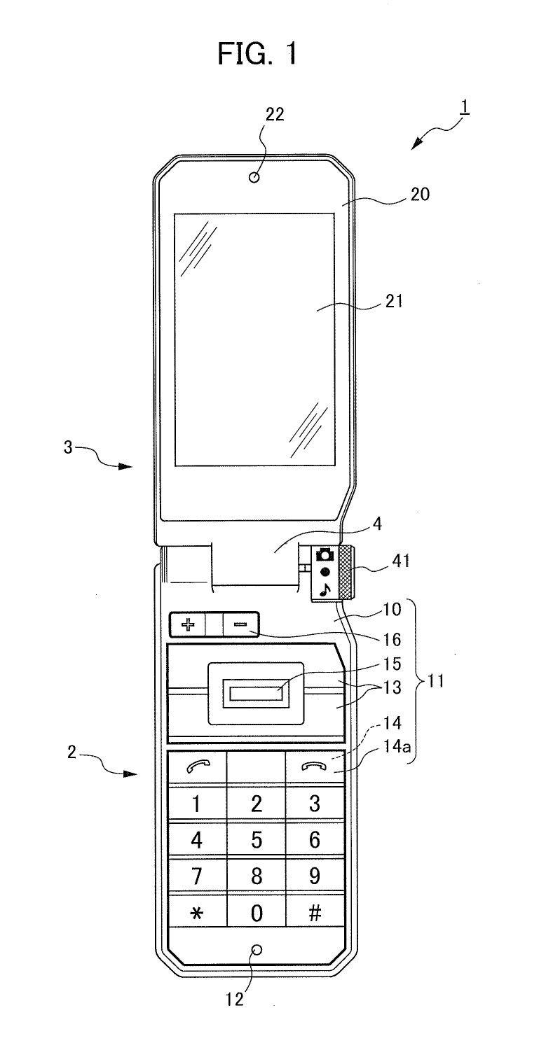

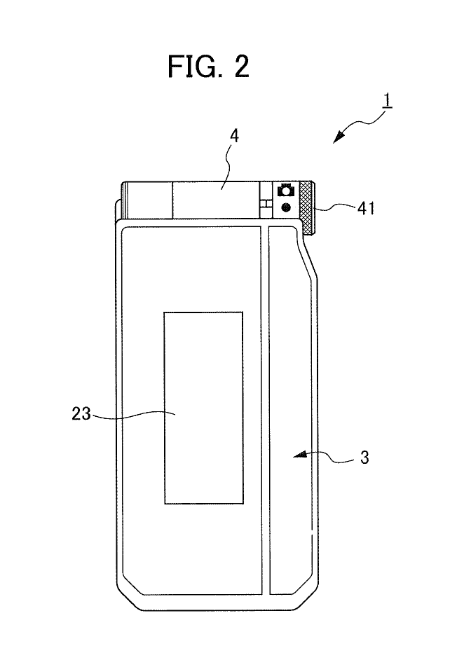

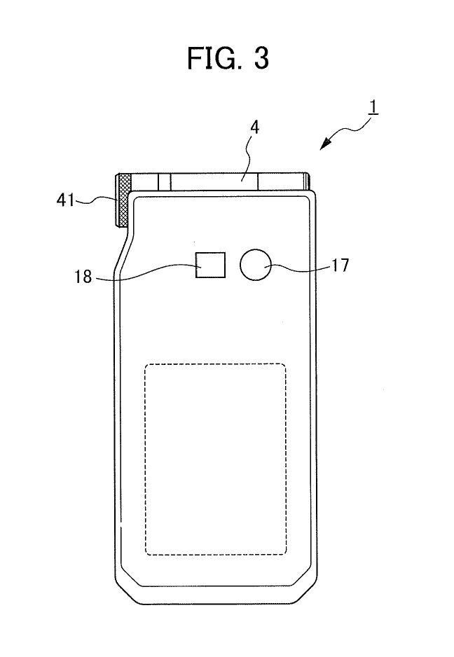

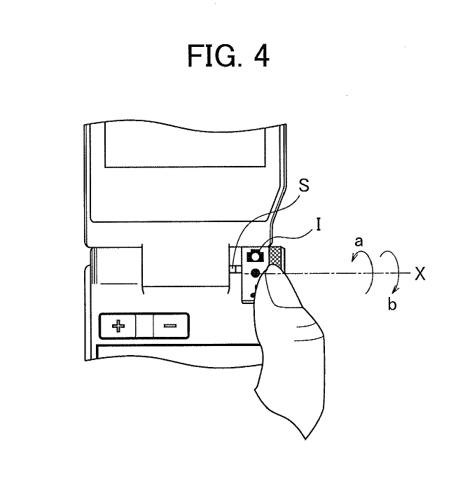

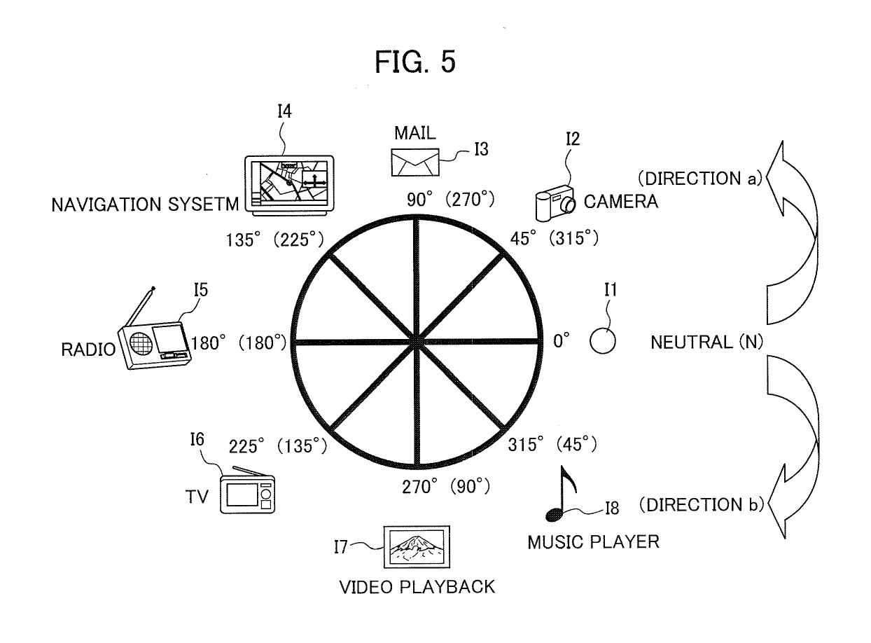

A description is provided hereinafter regarding an embodiment of the present invention. FIG. 1 shows an external view of the cellular telephone 1 that is an example of the portable electronic equipment according to the present invention. FIG. 2 shows an external view of the cellular telephone 1 in a closed state, which is viewed from a display unit side body 3. FIG. 3 shows an external view of the cellular telephone 1 in a closed state, which is viewed from an operation unit side body 2. FIG. 4 shows an enlarged view of a vicinity of a rotary dial portion. FIG. 5 is a diagram showing functions of the rotary dial portion. It should be noted that, although a cellular telephone is described hereinafter, the present invention is not limited thereto, and may be a PHS (Personal Handyphone System), a PDA (Personal Digital Assistant), a portable navigation device, a notebook PC or the like.

As shown in FIG. 1, the cellular telephone 1 is configured to include the operation unit side body (body) 2 and the display unit side body (body) 3. The operation unit side body 2 is configured to include on a front face 10 thereof an operation key set 11 and a microphone 12 to which sounds, which a user of the cellular telephone 1 produces during a phone call, are input. The operation key set 11 includes feature setting operation buttons 13, input operation buttons 14, a selection operation button 15, and a control button 16. The feature setting operation buttons 13 are for operating various settings and various features such as a telephone number directory feature and a mail feature. The input operation buttons 14 are for inputting digits of a telephone number and characters for mail. The selection operation button 15 is for performing selection of the various operations, scrolling and the like. The control button 16 is for performing control such as volume control.

A display 21 for displaying a variety of information, and a sound output unit 22 for outputting sound of the other party of the conversation are disposed on the display unit side body 3.

An upper end portion of the operation unit side body 2 and a lower end portion of the display unit side body 3 are connected via a hinge mechanism 4. The cellular telephone 1 can be in a state where the operation unit side body 2 and the display unit side body 3 are apart from each other (opened state), and in a state where the operation unit side body 2 and the display unit side body 3 are contacting each other (folded state), as the operation unit side body 2 and the display unit side body 3, connected via the hinge mechanism 4, pivot with respect to each other.

It should be noted that, although FIG. 1 shows a so-called flip-type cellular telephone, the present invention is not limited thereto, and the cellular telephone 1 may be of, for example: a slider type in which one body slides to one direction from a state in which the operation unit side body 2 and the display unit side body 3 are mutually superimposed; or a rotating type (turning type) in which one body is rotated around an axis line along the direction in which the operation unit side body 2 and the display unit side body 3 are superimposed.

In addition, a rotary dial portion 41 is provided at a position where the hinge mechanism 4 is formed in the cellular telephone 1. The rotary dial portion 41 is attached so as to be rotatable in a predetermined direction. Although the rotary dial portion 41 is attached to a tip portion of the operation unit side body 2 according to FIG. 1, the present invention is not limited thereto. Operations and functions of the rotary dial portion 41 are described later.

Furthermore, as shown in FIG. 2, the display unit side body 3 is provided with a sub display 23 that displays predetermined information, on a reverse side of a side on which the display 21 is disposed. Moreover, as shown in FIG. 3, an imaging portion 17 configured with a CCD (Charge Coupled Device) camera for taking an image of a subject and the like, and a light-emitting portion 18 that outputs a certain amount of light are provided in the operation unit side body 2, on a reverse side of a side on which the operation key set 11 is disposed.

Next, operations and functions of the rotary dial portion 41 are described. The rotary dial portion 41 is attached to the body so as to be rotatable in predetermined directions (direction a and direction b in FIG. 4) by a user's finger, about a rotational axis X of the hinge mechanism 4. It should be noted that the rotary dial portion 41 is not limited to the configuration shown in FIG. 4 and can be of any configuration in which the rotary dial portion 41 is rotatable by a user's operation, such as a configuration in which the rotary dial portion 41 is rotatable in predetermined directions about an axis orthogonal to the rotational axis (hinge axis) X.

A plurality of icons I (I1 to I8) are allocated on the rotary dial portion 41 at predetermined intervals in a rotation direction. As shown in FIG. 5, for example, the icons I are represented by images that are easy for the user to understand, as signs used in selecting an application.

Here, user's operations of the rotary dial portion 41 are briefly described. The user moves an icon I corresponding to a desired application to the selection position S by using the icons I as clues. And then, the cellular telephone 1 activates an application corresponding to the icon I resting at the selection position S. In this way, the rotary dial portion 41 makes it possible to select menus for achieving various functions by the operation of the physical rotary dial.

More specifically, as shown in FIG. 5, when the rotary dial portion 41 is rotated 45 degrees in the direction a (315 degrees in the direction b) relative to the non-operation time (the icon I1 positioned at neutral (N)) by the user's rotation operation, and then a predetermined time period has elapsed or a confirmation operation is performed after that the icon I2 rests at a selection position S, the cellular telephone 1 activates the camera function of the imaging portion 17 to enter a state in which imaging of a subject is possible.

In addition, when the rotary dial portion 41 is rotated 90 degrees in the direction a (270 degrees in the direction b) relative to the icon I1, and then a predetermined time period has elapsed or a confirmation operation is performed after that the icon I3 representing the mail application rests at the selection position S, the cellular telephone 1 activates the mail application to enter a state in which viewing, drafting and sending of a mail are possible.

Similarly, the cellular telephone 1 activates respectively: a navigation guiding application when the rotary dial portion 41 is rotated 135 degrees in the direction a (225 degrees in the direction b); a radio application when the rotary dial portion 41 is rotated 180 degrees in the direction a (180 degrees in the direction b); an application allowing TV viewing when the rotary dial portion 41 is rotated 225 degrees in the direction a (135 degrees in the direction b); a data folder application showing images when the rotary dial portion 41 is rotated 270 degrees in the direction a (90 degrees in the direction b); and a music playing application when the rotary dial portion 41 is rotated 315 degrees in the direction a (45 degrees in the direction b), relative to the icon I1.

It should be noted that the abovementioned menus allocated to rotation amounts of the rotary dial portion 41 are examples, and the present invention is not limited thereto. For example, a configuration may be employed in which a menu that is frequently used by the user can be registered. In addition, a configuration may be employed in which a desired Web address is allocated in advance to a predetermined rotation amount of the rotary dial portion 41, and when the Web address is selected, a Web browser is activated to enable browsing of a Web page of the Web address. Furthermore, the number of the applications allocated to the rotary dial portion 41 is not limited either to the aforementioned number (seven).

In addition, the user can directly activate the various functions assigned to the rotary dial portion 41 under certain conditions, by directly operating the rotary dial portion 41. Accordingly, it is not necessary to go through the main menu, and it is possible to easily activate a desired application. In addition, by using a method of selecting an application by the rotary dial portion 41 and a conventional method of going through the main menu in parallel, a wider variety of application selecting methods can be provided to users, thereby improving operability.

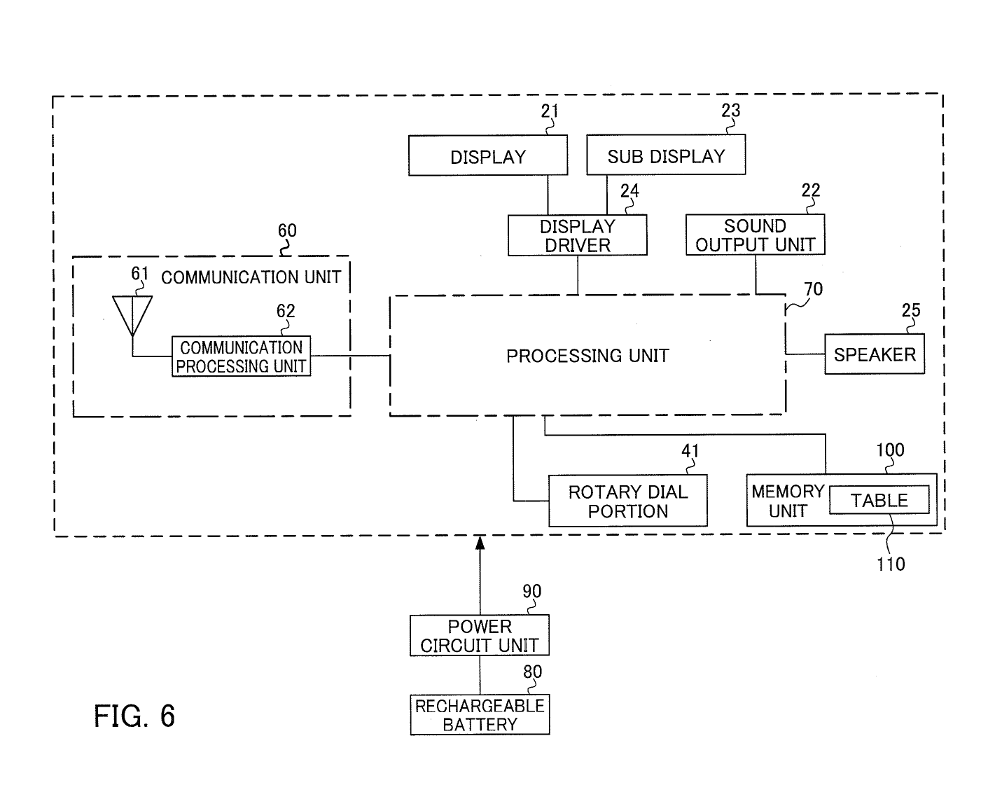

Next, configuration and operation of the cellular telephone 1 are described from a functional viewpoint with reference to FIG. 6. As shown in FIG. 6, the cellular telephone 1 is provided with: the display 21; the sound output unit 22; the sub display 23; a display driver 24; a speaker 25; the rotary dial portion 41; a communication unit 60; a processing unit 70; a rechargeable battery 80; a power supply circuit unit 90; and a memory unit 100. The display 21 is a display unit for various information and configured not to be exposed to the outside in the closed state. The sound output unit 22 outputs sound of other party during a call. The sub display 23 is a display unit for carious information and configured to be exposed to the outside even in the closed state. The display driver 24 drives the display 21 and the sub display 23. The speaker 25 outputs music and the like that are played to the outside. It should be noted that, although the display 21 and the sub display 23 are configured to be driven by the display driver 24 in the present embodiment, the present invention is not limited thereto and the displays can be configured respectively with dedicated drivers.

The communication unit 60 is provided with: the main antenna 61 that performs communications with an external device at a predetermined frequency band to be used; and the communication processing unit 62 that performs signal processing such as modulation processing or demodulation processing. The main antenna 61 performs communication with the external device (base station) at a predetermined frequency band to be used (e.g., 800 MHz). It should be noted that, although the predetermined usable frequency band is set to 800 MHz in the present embodiment, other frequency bands can also be used. Moreover, in addition to the predetermined frequency band to be used, the main antenna 61 may be configured with a so-called dual band adaptive type that is adaptive to a second frequency band to be used (e.g., 2 GHz), and furthermore, it may be configured with a multiple band adaptive type that is adaptive to a third frequency band to be used.

The communication processing unit 62 applies demodulation processing to signals received by the main antenna 61, and supplies the processed signals to the processing unit 70, while the communication processing unit 62 applies modulation processing to the signals supplied from the processing unit 70, and transmits the signals to the external device (base station) through the main antenna 61. The power supply circuit unit 90 transforms a power supply voltage, which is supplied from the rechargeable battery 80, to a predetermined voltage value, and supplies the transformed voltage to the communication unit 60, the processing unit 70 and the like.

The memory unit 100 stores a number of programs that are executed by the processing unit 70, parameters, various tables and the like. More specifically, the memory unit 100 stores: a number of application programs, of which activation, termination, interruption and the like are performed by the processing unit 70; parameters that are used by the plurality of applications; an OS (Operating System) program for operating the plurality of application programs; and a table 100 that indicates the corresponding relationship between the detected rotation amount and the plurality of applications (refer to FIG. 5) and whether or not the applications are activatable in the closed state. It should be noted that the plurality of application programs include application programs for each application that the cellular telephone 1 has, such as a standard application, a music player, a camera and mail.

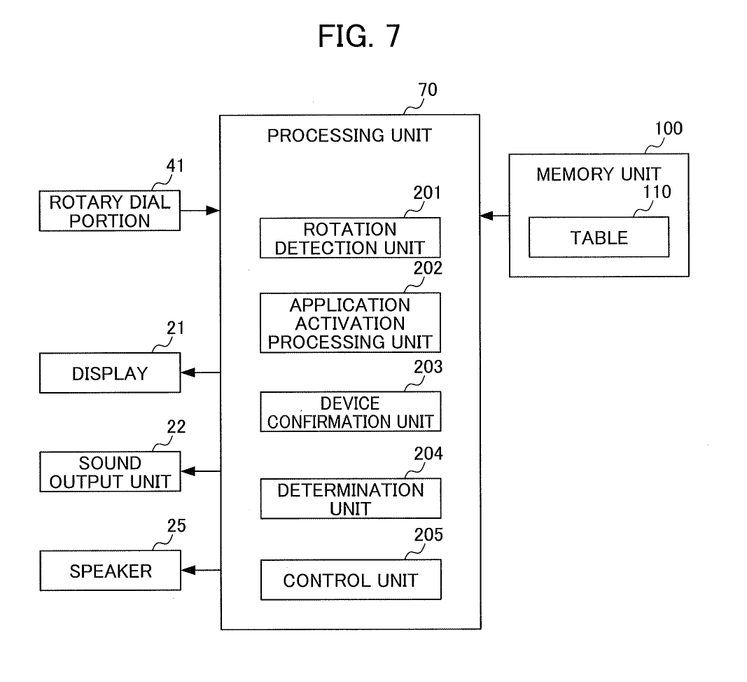

The cellular telephone 1 thus configured provides speedy operability with no discomfort by employing a rotary dial, and has operability of functions that is more suitable for an actual mode of usage by a user. In addition, the cellular telephone 1 has a function of suppressing frequent switching of devices, thereby reducing the electric power consumption. Next, a specific configuration of the processing unit 70 for realizing the function is described with reference to the functional block diagram shown in FIG. 7. As shown in FIG. 7, the processing unit 70 is provided with: the rotation detection unit 201; an application activation processing unit 202; a device confirmation unit 203; a determination unit 204; and a control unit 205.

The rotation detection unit 201 detects rotation of the rotary dial portion 41. It should be noted that, although the rotation detection unit 201 detects an amount of change of the angle of the rotary dial portion 41 as the rotation amount in the present embodiment, it is not limited thereto and any change depending on the rotation of the rotary dial portion 41, such as a change of resistivity, may be detected.

Based upon the rotation detected by the rotation detection unit 201, the application activation processing unit 202 activates a predetermined application among a plurality of applications. The application activation processing unit 202 has a function for controlling to activate a predetermined application corresponding to the detected rotation amount, and to display a display screen corresponding to the predetermined application thus activated, on the display 21.

Here, operations of the application activation processing unit 202 are described. The application activation processing unit 202 references the table 110 for the application correspondence relationship in the memory unit 100 every time the rotary dial portion 41 is rotated, and identifies an application corresponding to the rotation amount. When the power supply of the cellular telephone 1 is turned on, the application activation processing unit 202 firstly stars up the OS program, and activates the standard application program under the control of the OS, thereby displaying a standby screen on the display 21. Subsequently, every time an application to be activated arises, the application activation processing unit 202 performs control to activate a new application program is activated by terminating or interrupting the standard application program under the control of the OS. By this processing, application activation processing unit 202 performs control to display a screen based on the newly activated application in place of the standby screen on the display 21. It should be noted that, also in a case in which an application program that has been activated is an application program other than the standard application program, application activation processing unit 202 terminates the application program that has been activated and activates a new application program. The application activation processing unit 202 controls so as to change from the screen based on the previous application program to a screen based on the new application program.

The device confirmation unit 203 confirms a device used by an application activated by the application activation processing unit 202. More specifically, the device confirmation unit 203 inquires at the application activation processing unit 202 about an application to be activated, and confirms a device by referring to a device control table stored in the storage unit 100. The device control table is a table that represents correspondence between the applications and devices used. As used herein, the “device” includes a camera, an LCD, an LED, a coprocessor, an application processor and the like.

The determination unit 204 determines whether a device confirmed by the device confirmation unit 203 is the same as a device that is active when start of rotation of the rotary dial portion 41 is detected by the rotation detection unit 201. More specifically, the determination unit 204 inquires at the application activation processing unit 202 about an active application, and confirms a device in use by referring to the device control table stored in the storage unit 100.

The control unit 205 controls to maintain a state where the currently activated device is activated in a case in which the determination unit 204 determines that the confirmed device is the same as the device that is active.

In such a configuration, in a case in which an activation operation of another application (hereinafter referred to as an application AP2) is performed while an application (hereinafter referred to as an application AP1) is active, the cellular telephone 1 determines whether a device used by the application AP1 is the same as a device used by the application AP2, and maintains an active state of the device, without quitting the device upon termination of the application AP1. As a result, frequent switching of the devices can be suppressed, thereby reducing the electric power consumption.

In addition, it is preferable that the plurality of applications is allocated such that applications using the same device are marked adjacently to each other in the rotary dial portion 41. For example, if a music playing application and an image browsing application use the same device, these applications are allocated adjacently to each other in the rotary dial portion 41. As a result, in a case in which activation of the image browsing application is selected while the music playing application is active, the device is not quitted and remains in an active state. This allows quick display of an image immediately after activating the image browsing application.

In addition, it is preferable that the control unit 205 controls the device that is active to be inactivated and controls the device confirmed by the device confirmation unit 203 to be activated, in a case in which the determination unit 204 determines that the confirmed device is not the same as the device that is active. In such a configuration, the cellular telephone 1 controls the active device to be inactivated, as in the conventional technique, when the active device is not the same as the confirmed device. This provides an effect of preventing unnecessary electric power consumption.

In addition, in a case in which the determination unit 204 determines that the confirmed device is not the same as the device that is active, it is preferable that the control unit 205 determines whether an application executed by the device that is activated is an application that can continue execution in an inactive state (a so-called background state), and, if the application is determined to be the application that can continue execution in the inactive state, controls to maintain the device that is active in the active state and maintain the execution of the application in the inactive state.

In such a configuration, if the application that is currently active is an application that can continue execution in the inactive state, the cellular telephone 1 executes the active application in the inactive state on condition of using a different device from that of an application to be newly activated, thereby realizing operability of functions that is more suitable for an actual mode of usage by a user.

In addition, in a case in which the determination unit 204 determines that the confirmed device is not the same as the device that is active, it is preferable that the control unit 205 determines whether an application executed by the device that is activated is an application that can continue execution in an inactive state, and, if the application is determined to be the application that can continue execution in the inactive state, notifies with information for determining whether to maintain the device in the active state or to inactivate the device.

In such a configuration, if the application that is currently active is an application that can continue execution in the inactive state, the cellular telephone 1 allows a user to determine whether or not to execute the active application in the inactive state on condition of using a different device from that of an application to be newly activated, thereby realizing operability of functions that is more suitable for an actual mode of usage by a user.

The application that can continue execution in the inactive state is at least any one of: the music playing application that plays music data stored in memory; a video playing application that converts received signal into video and sound and outputs the video and the sound; a sound output application that converts received signal into sound and outputs the sound; and an application that outputs sound from a voice guiding application that guides a user with voice to a destination based on positional information, to the outside.

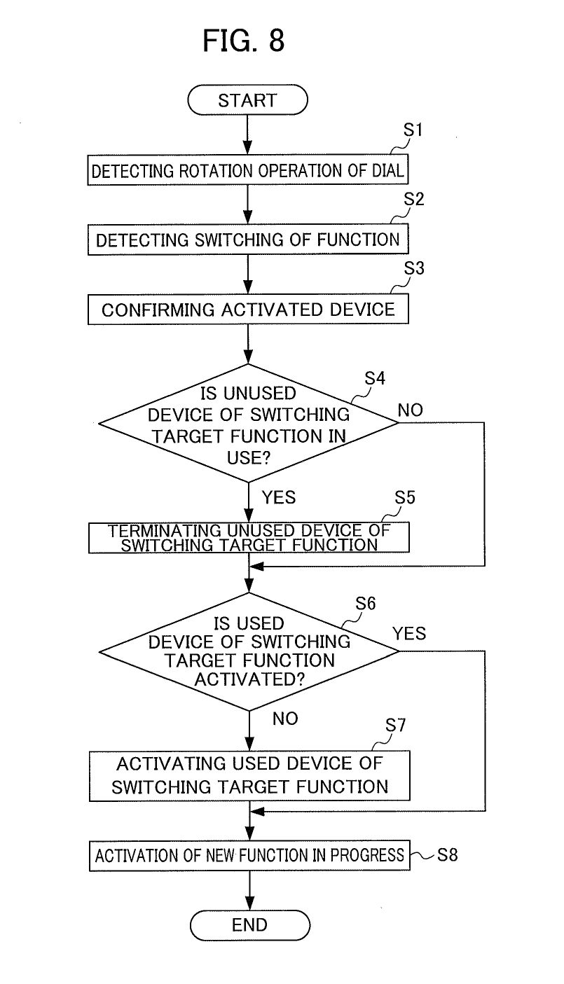

Next, operations of the cellular telephone 1 are described with reference to a flowchart shown in FIG. 8. In Step S1, the rotation detection unit 201 detects rotation operation of the rotary dial portion 41.

In Step S2, the application activation processing unit 202 detects that a function is switched, in other words, selection of an application, based on the rotation operation detected in Step S1. The application activation processing unit 202 prepares activation of the selected application.

In Step S3, the device confirmation unit 203 confirms a device used by the selected application. The device confirmation unit 203 confirms a device used by the application that is currently activated, for example by referring to the device control table stored in the storage unit 100.

In Step S4, the determination unit 204 determines whether an unused device of a switching target function is in use or not, in other words, whether a device that is not used by the application selected in Step S2 is in use or not. In a case in which the unused device is determined to be in use (Yes), the processing advances to Step S5, and in a case in which the unused device is determined to be not in use (No), the processing advances to Step S6.

In Step S5, the control unit 205 inactivates the unused device of the switching target function. The control unit 205 can continue using the application currently activated in the inactive state without inactivating the unused device, if the application is executable in the inactive state (background state).

In Step S6, the control unit 205 determines whether a used device of the switching target function is in used or not, in other words, whether a device that is used by the application selected in Step S2 as an activation target is in use or not. In a case in which the used device is determined to be activated (Yes), the processing advances to Step S8. In other words, the control unit 205 maintains the used device in an active state in a case in which the used device is determined to be activated. On the other hand, in a case in which the used device is determined not to be activated (No), the processing advances to Step S7.

In Step S7, the control unit 205 activates the used device of the switching target function.

In Step S8, the application activation processing unit 202 activates the application selected in Step S2.

Thus, in a case in which an activation operation of another application (application AP2) is performed while an application (application AP1) is active, in a case in which a device that is currently activated is the same as a device used by the application AP2, the cellular telephone 1 maintains an active state of the device, without quitting the device upon termination of the application AP1. As a result, frequent switching of the devices can be suppressed, thereby reducing the electric power consumption.

Although it has been described in the above embodiment that frequent switching of devices is controlled by confirming usage of devices used by and not used by an application to be activated, the present invention is not limited thereto. For example, frequent switching of devices can also be controlled by: determining whether a device used by an application to be activated is the same as a device that is already activated; and, in a case these devices are determined to be the same, maintaining the device in an activated state.

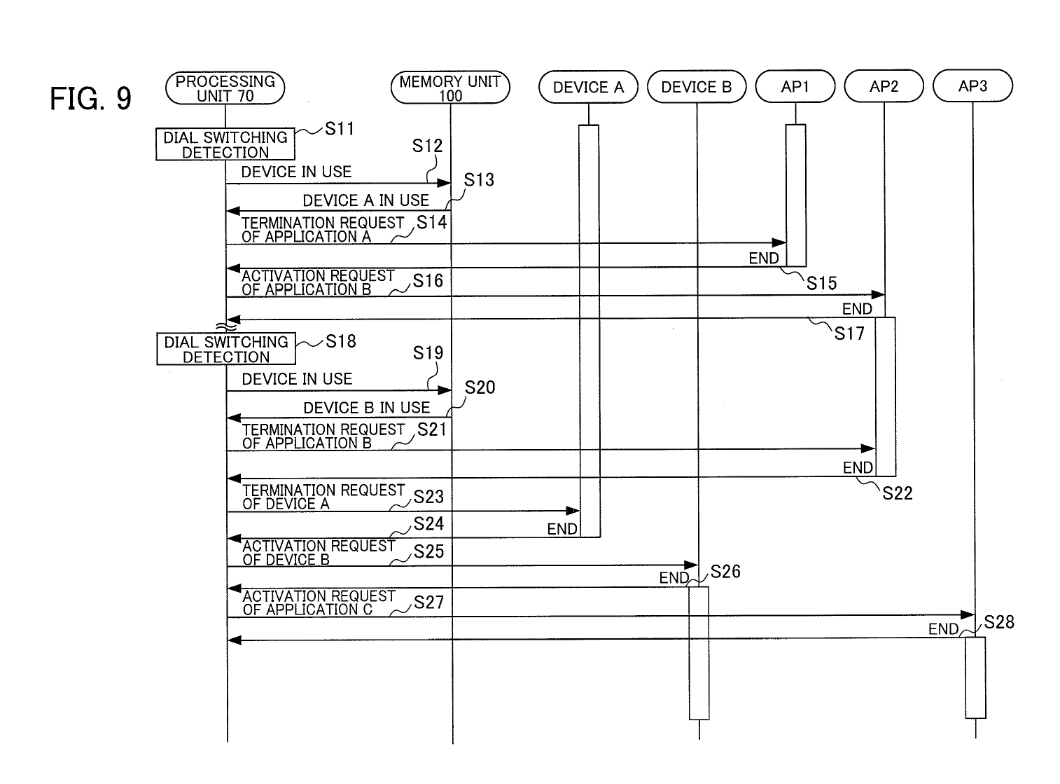

Next, an operation of switching devices upon activation of an application is described in detail with reference to a timing chart shown in FIG. 9. Hereinafter, an operation of activating the application AP2 in a state in which the application AP1 has already been activated, and then activating an application AP3 is described as an example of an operation of switching applications. The applications AP1 and AP2 use a device A and the application AP3 uses a device B that is different from the device A.

The processing unit 70 detects switching of the rotary dial portion 41 (Step S11) and, if activation of the application AP2 is detected, confirms a device used by the application AP2 by referring to the memory unit 100. The processing unit 70 determines that the device used by the application AP2 is the device A (Step S13) and requests termination of the application AP1 (Step S14). If the processing unit 70 receives notification of completion of termination of the application AP1 (Step S15), the processing unit 70 requests activation of the application AP2 without terminating the device A (Step S16), and receives notification of completion of activation of the application AP2 (Step S17).

In addition, the processing unit 70 detects switching of the rotary dial portion 41 (Step S18), and, if activation of the application AP3 is detected, confirms a device used by the application AP3 by referring to the memory unit 100. The processing unit 70 determines that the device used by the application AP3 is the device B (Step S20) and requests termination of the application AP2 (Step S21). If the processing unit 70 receives notification of completion of termination of the application AP2 (Step S22), the processing unit 70 requests termination of the device A (Step S23).

If the processing unit 70 receives notification of completion of termination of the device A (Step S24), the processing unit 70 requests activation of the device B (Step S25). If the processing unit 70 receives notification of activation of the device B (Step S26), the processing unit 70 requests activation of the application AP3 (Step S27), and receives notification of completion of activation of the application AP3 (Step S28).

Thus, as the application AP1 and the application AP2 use the same device A, the cellular telephone 1 controls switching from the application AP1 to the application AP2 while maintaining an active state of the device A. As a result, frequent switching of the devices can be suppressed, thereby reducing the electric power consumption.

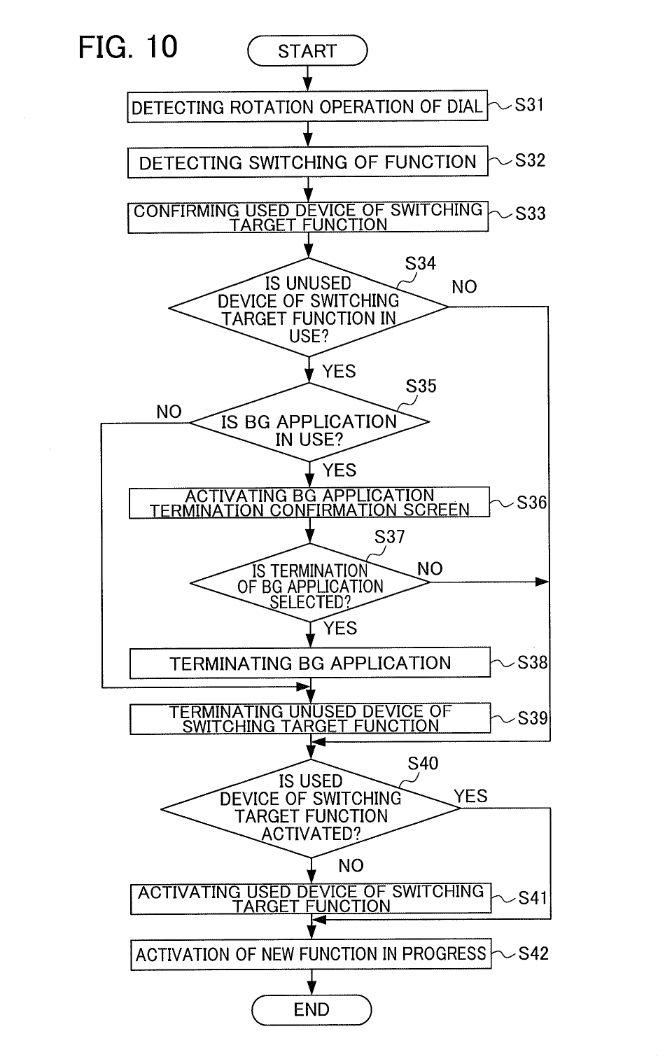

Next, operations of the cellular telephone 1 in a case in which an activation operation of a new application is performed during use of an application that is executable in an inactive state (background state) are described with reference to a flowchart shown in FIG. 10. In Step S31, the rotation detection unit 201 detects rotation operation of the rotary dial portion 41.

In Step S32, the application activation processing unit 202 detects that a function has been switched, in other words, selection of an application, based on the rotation operation detected in the step S31. The application activation processing unit 202 prepares activation of the selected application.

In Step S33, the device confirmation unit 203 confirms a device used by the selected application. The device confirmation unit 203 confirms a device used by the application that is currently activated, for example by referring to the device control table stored in the storage unit 100.

In Step S34, the determination unit 204 determines whether an unused device of a switching target function is in use or not, in other words, whether a device that is not used by the application selected in Step S32 is in use or not. In a case in which the unused device is determined to be in use (Yes), the processing advances to Step S35, and in a case in which the unused device is determined to be not in use (No), the processing advances to Step S40.

In Step S35, the control unit 205 determines whether the unused device is used by an application executable in an inactive state (hereinafter referred to as a BG application) or not. In a case in which the unused device is determined to be in use (Yes), the processing advances to Step S36, and in a case in which the unused device is determined to be not in use (No), the processing advances to Step S39.

In Step S36, the control unit 205 activates a screen for confirmation of termination of the BG application. Alternatively, the control unit 205 can prompt confirmation of termination by sound or the like, not by the screen. In such a configuration, the control unit 205 determines whether the BG application is to be terminated or not by existence of a predetermined operation for termination of the BG application.

In Step S37, the control unit 205 determines whether termination of the BG application has been selected or not. In a case in which termination of the BG application is determined to be selected (Yes), the processing advances to Step S38, and in a case in which termination of the BG application is determined not to be selected (No), the processing advances to Step S40.

In Step S38, the control unit 205 controls to terminate the BG application.

In Step S39, the control unit 205 terminates the unused device of the switching target function.

In Step S40, the control unit 205 determines whether a used device of the switching target function is in used or not, in other words, whether a device that is used by the application selected in Step S23 as an activation target is in use or not. In a case in which the used device is determined to be activated (Yes), the processing advances to Step S8. In other words, the control unit 205 maintains the used device in an active state in a case in which the used device is determined to be activated. On the other hand, in a case in which the used device is determined not to be activated (No), the processing advances to Step S7.

In Step S41, the control unit 205 activates the used device of the switching target function.

In Step S42, the application activation processing unit 202 activates the application selected in Step S32.

In such a configuration, if the application that is currently active is a BG application and a device used by the BG application is an unused device by an application to be activated, the cellular telephone 1 allows a user to determine whether or not to execute the BG application in the inactive state, thereby realizing operability of functions that is more suitable for an actual mode of usage by a user.

It should be noted that, although an example is shown in which an application to be activated is identified based on the rotation amount of the rotary dial portion 41 in the present embodiment, it is not limited thereto. In other words, only a rotation state has to be determined, and in addition to detection of a changed amount, for example, a configuration may be employed in which only a final rotation position is detected. Moreover, by storing the final rotation positions being respectively associated with the applications in the table 110, it is also possible to configure such that an application corresponding to an identified position is activated by referring to the table 110.

Furthermore, it may be configured such that a time from starting rotation to reaching a final rotation position is measured, thereby determining whether the rotation is fast or slow, and an application to be activated is changed in accordance thereto. In this case, by storing the rotation times being respectively associated with the applications to be activated in the table 110, and referring to the table regarding the time from the start of the rotation to the end of the rotation, for example, it is also possible to activate different applications depending on the difference of the rotation speed, even in a case in which the rotation is performed to the same position.

1. Portable electronic equipment comprising: a body;
a rotary dial portion that is attached to the body so as to be rotatable;
a rotation detection unit that detects rotation of the rotary dial portion;
an application activation processing unit that activates a predetermined application among a plurality of applications based upon the rotation detected by the rotation detection unit;
a device confirmation unit that confirms a device used by a new application activated by the application activation processing unit;
a determination unit that determines whether the first device is the same as a second device that is active when start of rotation of the rotary dial portion is detected; and
a control unit that maintains a state where the second device is activated in a case in which the determination unit determines that the first device is the same as the second device.

2. The portable electronic equipment according to claim 1, wherein the application activation processing unit determines the new application by identifying a rotation position of the rotary dial portion.

3. The portable electronic equipment according to claim 2, wherein the rotary dial portion is provided with a plurality of icons and
wherein, among the plurality of icons, at least two adjacent icons correspond to two applications that use the same device.

4. The portable electronic equipment according to claim 1, wherein applications that use the same device are allocated adjacently to each other in the rotary dial portion.

5. The portable electronic equipment according to claim 1, wherein the control unit quits the second device and controls the first device confirmed by the device confirmation unit to be activated, in a case in which the determination unit determines that the first device is not the same as the second device.

6. The portable electronic equipment according to claim 1, wherein: in a case in which the determination unit determines that the first device is not the same as the second device, the control unit determines whether the second device is of a type that maintains operation in an inactive state of the current application; and,
in a case in which the control unit determines that the second device is of the type that maintains operation in the inactive state, the control unit does not quit the second device that is currently active.

7. The portable electronic equipment according to claim 6, wherein, in a case in which the control unit determines that the second device is of the type that maintains operation in the inactive state, the control unit executes the new application and activates the first device without quitting the second device.

8. The portable electronic equipment according to claim 1, wherein, in a case in which the determination unit determines that the first device is not the same as the second device, the control unit determines whether the second device is of a type that maintains operation in an inactive state of the current application and,
in a case in which the control unit determines that the second device is of the type that maintains operation in the inactive state, the control unit outputs information for determination of whether operation of the second device should be maintained or quitted.

9. The portable electronic equipment according to claim 6, wherein a condition for determining that the second device is of the type that maintains operation in the inactive state is that the current application is at least one of the following:
A. a music playing application that plays music data stored in memory;
B. a video playing application that converts received signal into video and sound and outputs the video and the sound;
C. a sound output application that converts received signal into sound and outputs the sound; and
D. a guiding application that guides a user to a destination based on positional information.

10. The portable electronic equipment according to claim 1 further comprising: a storage unit that stores a control table that represents correspondence between the plurality of applications and devices used by each application,
wherein the device confirmation unit confirms a device used by the new application by referring to the control table stored in the storage unit.

11. An application activation control method for a portable electronic equipment with a rotary dial portion rotatably attached thereto, the method comprising:
a detection step of detecting rotation of the rotary dial portion;
an application activation step of activating a predetermined application among a plurality of applications based upon the rotation detected in the detection step;
a confirmation step of confirming a device used by a new application activated in the application activation step;
a determination step of determining whether a first device confirmed in the confirmation step is the same as a second device that is active when start of rotation of the rotary dial portion is detected; and
a control step of maintaining a state where the second device is activated in a case in which, in the determination step, the first device is determined to be the same as the second device.
